(19) United States
(12) Patent Application Publication
(10) Pub. No.: US 2010/0254749 A1
(43) Pub. Date: Oct. 7, 2010

(54) Fabric Treatment Applicator

(75) Inventors: Fabio Amiconi, Carbonera (IT); Luca Spadoni, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: RECKITT BENCKISER N.V., Hoofddorp (NL)

(21) Appl. No.: 12/094,204

(22) PCT Filed: Nov. 11, 2006
(86) PCT No.: PCT/GB2006/004214

§ 371 Date: May 30, 2008

(30) Foreign Application Priority Data
Nov. 22, 2005 (GB) 0523712.8
Dec. 6, 2005 (GB) 0524821.6

(51) Int. Cl. B05C 21/00

(52) U.S. Cl. 401/196

(57) ABSTRACT

A fabric treatment applicator comprises a housing and an application member. The housing includes a fabric treatment composition. The application member has a frictional stress value of less than 0.05 Nmm⁻².

The present invention relates to an applicator for a fabric treatment composition.

Stain removers for a liquid composition, for pre laundry application are well known.

U.S. Pat. No. 5,288,420 discloses a stain removal composition provided in form of a solid stick, which can be applied to selected areas of a fabric in laundry preparations.

DE 2422191 discloses a solution to be used on stains provided in an applicator with a felt insert. DE 19536714 discloses an applicator for a stain removal fluid which takes the form of a pen. WO 99/02769 discloses an impregnated towelette to clean stains from clothes comprising surfactant.

In view of the above prior art it is an object of the present invention to provide an improved fabric treatment applicator.

According to a first aspect of the present invention there is provided a fabric treatment applicator comprising a housing and an application member, the housing including a fabric treatment composition, wherein the application member has a frictional stress value of less than 0.05 Nmm⁻².

More preferably the application member has a frictional stress value of less than 0.04 Nmm⁻², less than 0.03 Nmm⁻², less than 0.01 Nmm⁻², e.g. about 0.0025 Nmm⁻².

The application device, as used herein, is a device which in use is in contact with the surface on which the fabric treatment applicator is used and delivers the fabric treatment composition to that surface. The fabric may be being worn at the time of use, wherein the use is out of home stain treatment or as a pre-wash step before a washing operation. Therefore according to a second aspect of the present invention there is provided a method of treating a fabric comprising the use of a fabric treatment applicator of the first aspect of the present invention on the fabric.

It is believed that the performance of the applicator device with regard to stain removal is influenced by the friction induced by the application device upon a fabric.

The frictional stress value is defined as the force exerted upon a reference fabric per unit area of real contact and is measured as given below.

The frictional stress of an application device, [sigma], is defined as:

σ=F/A=μR/A

where F is the frictional force, A the contact area, μ the coefficient of friction and R the reaction to the normal load.

Preferred applicators comprise a housing comprising reservoir for the storage of a fabric treatment composition. Such a housing may be a bottle of any shape or size. Most preferably the housing resembles in shape a pen.

The applicator member is in fluid communication with the reservoir.

The applicator member may be any shape that allows it to perform its function. Preferred shapes includes rectangles and circles. The surface of the applicator member intended to touch the fabric when in use is preferably planar.

The applicator member preferably co-operates with a lid when not in use to prevent accidental discharge of the fabric treatment composition/drying of the applicator. Generally the applicator member has a similar size to the housing with which it is connected. In this regard normally the applicator has a surface area of up to 20 cm², more preferably up to 15 cm². more preferably up to 10 cm² and most preferably up to 10 cm².

Preferably the application member comprises an elastomeric or plastics foam or sponge material, such as a polyester-urethane, a polypropylene-polyethylene or a polyurethane foam. The density of the member is preferably from 35 to 130 kg/m³. The foam may be injection moulded. The sponge may be comprised of a foam of open-cell material, or a reticulated foam. A preferred foam or sponge for this purpose has the property that a vertical load of 1.5 Kg will compress a 70 mm diameter sphere of the material by 10-30 mm.

The fabric treatment composition is preferably formulated such that it is easily dispensed. Preferably the fabric treatment composition is a liquid/gel.

Preferably the fabric treatment composition comprises a bleach. Where present the composition comprises from 0.001% to 99.99%, preferably 0.001% to 7%, preferably 2% to 6%, most preferably about 7%, by weight, of bleach. The bleach is preferably peroxide bleach, most preferably hydrogen peroxide. Peroxide sources other than H₂O₂ can be used.

Where a bleach is present it will be appreciated that the application member may be self-cleaning. Namely any stain which has been absorbed from an item of fabric onto/into the application member may be removed/rendered less visible by being exposed to bleach. Thus according to a third aspect of the invention there is provided a fabric treatment applicator comprising a housing and an application member, the housing comprising a fabric treatment composition including a bleach, wherein the application member is self-cleaning.

Preferably the application member is a sponge (as described above) and thus according to a fourth aspect of the invention there is provided a fabric treatment applicator comprising a housing and an application member in the form of a sponge, the housing comprising a fabric treatment composition including a bleach, wherein the application member is self-cleaning.

Preferably the sponge has the friction co-efficient (as described above) and thus according to a fifth aspect of the invention there is provided a fabric treatment applicator comprising a housing and an application member in the form of a sponge, the housing comprising a fabric treatment composition including a bleach, wherein the application member has a frictional stress value of less than 0.05 Nmm⁻².

Where a bleach (or other oxidising agent) is present it will also be appreciated that the application member may be self-heating. The heating can aid treatment of the fabric substrate. Reaction of the bleach with a component present in the application member (e.g. a reducing agent) can be used to cause heating of the application member. The component that reacts with the bleach maybe impregnated into the application member. Alternatively this component may be brought into contact with the application member from a different source, e.g. from a second chamber of the housing or from the fabric itself.

Preferably the fabric treatment composition comprises a surfactant. Where present the composition comprises from 0.001% to 99.99%, preferably 0.05% to 5%, by weight of surfactants.

The surfactant is, for example, an anionic or nonionic surfactant or mixture thereof. The nonionic surfactant is preferably a surfactant having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C12-15 alkanol condensed with 7 or 3 moles ethylene oxide (Neodol 25-7 or Neodol 25-3), C₁₄₋₁₅ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and oleoyl sarcosinates and mixtures thereof.

Preferably the fabric treatment composition comprises a solvent. Where present the composition comprises from 0% to 99.99% preferably from 0% to 10% by weight, of solvent.

The solvent constituent may comprise one or more alcohol, glycol, acetate, ether acetate or glycol ether. Exemplary alcohols useful in the compositions of the invention include C₂-C₈ primary and secondary alcohols which may be straight chained or branched, preferably pentanol and hexanol. More preferably the solvent is a glycol ether. Preferred examples of glycol ethers include glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

Specific and preferred solvents are selected from propylene glycol methyl ether, dipropylene glycol methyl ether, dipropylene glycol propyl ether, dipropylene glycol butyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

Most preferably the solvent or mixture of solvent is from the propanol series (Dowanol P-series) and among these Dipropylene Glycol n-Propyl Ether, Dipropylene Glycol n-Butyl Ether and Propylene Glycol Phenyl Ether. These are commercially available from Dow Chemicals as Dowanol DPnP, Dowanol DPnB and Dowanol PPH respectively.

Other useful solvents are hydrotropes such as sodium toluene sulfonate and sodium cumene sulfonate, short-chain alcohols such as ethanol and isopropanol; and the like. They can be present in the compositions as only solvents or in combination with other solvents.

Preferably the fabric treatment composition comprises a builder. Where present the composition comprises from 0% to 99.99% preferably from 0% to 10% by weight, of builder.

The fabric treatment composition may comprise minor amounts of various optional ingredients, including enzymes, preservatives, anti-static agents, fragrances, odour absorbing components

The pH range of the fabric treatment composition is typically in the from about 3 to about 8, preferably about 6.

The invention is now described with reference to the following non-limiting Example.

### Example of a Fabric Treatment Composition

Preferred examples of a fabric treatment composition are below.

| | Wt % | | |
|---|---|---|---|
| Component | Ex. 1 | Ex. 2 | Ex. 3 |
| Water | 76.4 | 77.0 | 82.0 |
| Dowanol DPnP | 10.0 | — | 10.0 |
| Genapol LA070 | 1.0 | — | — |
| SCS (40%) | 3.8 | — | — |
| Isopropanol (99%) | 3.0 | 3.0 | 3.0 |
| Acusol 445 | 0.6 | — | — |
| H₂O₂ (50%) | 4.0 | 4.0 | 4.0 |
| IDS (34%) | 1.3 | — | — |
| Silicone Emulsion | — | 15.0 | — |
| Propylene Glycol | — | 1.0 | 1.0 |

### Applicators

Generally any applicator comprising a application member having the right frictional co-efficient is within the scope of the present invention.

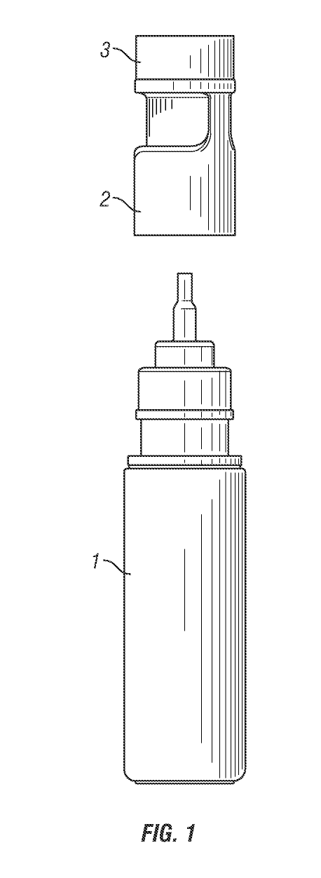

A preferred embodiment of an applicator is shown in FIG. 1.

This applicators comprising a housing (1) comprising a reservoir for the storage of a fabric treatment composition. The housing (1) is in the form of a pen.

The housing is connected to a collar (2) which includes a terminal application member (3), which is a sponge.

The applicator may also comprise a cap (not shown) to prevent evaporation of the composition and to prevent any unattended contact of the application member (3) with objects when not used.

1. A fabric treatment applicator comprising a housing and an application member, the housing including a fabric treatment composition, wherein the application member has a frictional stress value of less than 0.05 Nmm⁻².

2. A fabric treatment applicator according to claim 1, wherein the application member has a frictional stress value of less than 0.04 Nmm⁻².

3. A fabric treatment applicator according to claim 1, wherein the applicator member has a surface area of up to 20 cm².

4. A fabric treatment applicator according to claim 1 wherein the application member comprises an elastomeric or plastics foam or sponge material.

5. A fabric treatment applicator according to claim 1 wherein the fabric treatment composition is a liquid and/or a gel.

6. A fabric treatment applicator comprising a housing and an application member, the housing comprising a fabric treatment composition including a bleach, wherein the application member is self-cleaning.

7. A fabric treatment applicator comprising a housing and an application member in the form of a sponge, the housing comprising a fabric treatment composition including a bleach, wherein the application member is self-cleaning.

8. A fabric treatment applicator comprising a housing and an application member in the form of a sponge, the housing comprising a fabric treatment composition including a bleach, wherein the application member has a frictional stress value of less than 0.05 Nmm⁻².

9. A method of treating a fabric comprising the steps of:
providing a fabric treatment applicator according to and, contacting the fabric treatment applicator with a fabric in a fabric treatment operation.

10. A fabric treatment applicator according to claim 2 wherein the application member has a frictional stress value of less than 0.03 Nmm⁻², less than 0.01 Nmm⁻², e.g. about 0.0025 Nmm⁻².

11. A fabric treatment applicator according to claim 10 wherein the application member has a frictional stress value of less than 0.01 Nmm⁻².

12. A fabric treatment applicator according to claim 11 wherein the application member has a frictional stress value of less than 0.0025 Nmm⁻².

13. A fabric treatment applicator according to claim 3, wherein the applicator member has a surface area of up to 15 cm².

14. A fabric treatment applicator according to claim 13, wherein the applicator member has a surface area of up to 10 cm².

15. A fabric treatment applicator according to claim 1, wherein the applicator member has a surface area of up to 20 cm².

16. A fabric treatment applicator according to claim 1, wherein the applicator member has a surface area of up to 15 cm².

17. A fabric treatment applicator according to claim 1 comprising a housing and an application member, the housing comprising a fabric treatment composition including a bleach, wherein the application member is self-cleaning.

18. A fabric treatment applicator according to claim 1 comprising a housing and an application member in the form of a sponge, the housing comprising a fabric treatment composition including a bleach, wherein the application member has a frictional stress value of less than 0.05 Nmm⁻².

19. A fabric treatment applicator according to claim 18, wherein the application member has a surface area of up to 20 cm².
